(19) United States
(12) Patent Application Publication
(10) Pub. No.: US 2010/0014109 A1
(43) Pub. Date: Jan. 21, 2010

(54) METHOD TO REDUCE UNPRINTED SUBSTRATE WASTE DURING DIGITAL PRINTING

(75) Inventor: Eddy Debaere, Deinze Asten (BE)

Correspondence Address: AGFA;c/o KEATING & BENNETT, LLP, 1800 Alexander Bell Drive, SUITE 200, Reston, VA, 20191, US

(73) Assignee: AGFA GRAPHICS NV, Mortsel (BE)

(21) Appl. No.: 12/518,679

(22) PCT Filed: Dec. 7, 2007
(86) PCT No.: PCT/EP07/63506

§ 371 Date: Jun. 30, 2009

Related U.S. Application Data
(60) Provisional application No. 60/875,472, filed on Dec. 18, 2006.

(30) Foreign Application Priority Data
Dec. 12, 2006 (EP) 06125855.4

(51) Int. Cl. G06F 3/12; B41J 29/38

(52) U.S. Cl. 358/1.13; 347/5; 358/1.18

(57) ABSTRACT

A method for printing more than one print job on a web based printer divides the web into logical print zones. Print jobs are assigned to different print zones by a multiplexer. The width and length of the print zones can vary during the printing as function of the print jobs. The method reduces the waste of unprinted substrate.

### CROSS-REFERENCE TO RELATED APPLICATIONS

This application is a 371 National Stage Application of PCT/EP2007/063506, filed Dec. 7, 2007. This application claims the benefit of U.S. Provisional Application No. 60/875,472, filed Dec. 18, 2006, which is incorporated by reference herein in its entirety. In addition, this application claims the benefit of European Application No. 06125855.4, filed Dec. 12, 2006, which is also incorporated by reference herein in its entirety.

### BACKGROUND OF THE INVENTION

1. Field of the Invention

The present invention relates to the field of digital printing. More specifically the present invention relates to the field of digital printing devices such as inkjet and toner based printers suitable for applications including label printing, package printing, transactional printing and commercial printing. More specifically the present invention is related to digital imposition systems for such applications.

2. Description of the Related Art

Digital printing differs from conventional printing in that only a digital master exists of a document that is to be printed.

A typical digital printer architecture is shown in FIG. 1.

A user interacts with a document design application 100 running on a data processing system and defines a document.

The document is stored in a file as a series of printer commands 110. This file is sent to a rasterizer 120 which transforms the printer commands into a bitmap 130 having the same spatial and tonal resolution as the printing device. The bitmap is sent to the printing device 140.

The printing device marks a substrate in response to the density value of the pixels of the bitmap and the result is a printed product 150.

Printer commands are typically represented using a page description language. Examples of page description languages known in the art include PostScript (PS) developed and specified by Adobe Systems Inc., Portable Document Format (PDF) developed and specified by the same company and Extensible Paper Specification (XPS) developed by Microsoft Corp. These page description languages represent a page as a collection of graphic objects to be printed. A graphic object can be, for example, text, vector graphics or raster graphics.

Most objects have both contents and attributes. For example, a text block contains text, but also information on how the text should be rendered including a font selection, a font size and a font color. Similarly a graphic contains a graphic contour, but also information on how the contour should be rendered, including the color of a fill, the color and thickness of a boundary etc.

A page description language typically also makes use of a graphics state including translation, rotation and scaling information for rendering an object.

The existing page description languages have been designed to print documents that are printed page by page. This approach is suitable for printing a wide range of publications such as office documents, brochures, flyers, newspapers, magazines, packages etc.

The printing of a document that is represented in a page description language conceptually includes three steps. A first step consists of interpreting the printer commands of the graphic objects that belong to a single page. Interpretation involves translating the graphic objects represented in the page description language into graphic primitives that can be efficiently rasterized. In a next step the interpreted objects are rendered, i.e., a raster image—usually referred to as a bitmap—is calculated that represents the interpreted objects at the printer's resolution. In a final step this bitmap is sent to the printer.

To reduce memory requirements and to increase data processing speed, the second and the third steps can be subdivided into sub-steps, whereby every sub-step corresponds to the calculation of a partial bitmap of pixels and sending the partial bitmap to the printer. The partial bitmaps typically correspond with successive bands of rows of pixels.

Several options exist to organize the printing sequence of multiple copies of a multiple page document.

A first possibility is to print multiple copies of a first page of the document, next multiple pages of a second page and so on until multiple copies of all the pages of the document have been obtained. In a next step the pages are mechanically collated so that multiple copies of the multiple page document are obtained. This first approach is referred to as “mechanical collation”.

A second possibility is to print a first copy of all the pages of a multiple page document first, then a second copy, and so on, until all documents have been printed. This second approach is referred to as “digital collation”.

The second possibility avoids the need for a mechanical collator, but generally requires the concurrent storage of the bitmaps of all the pages of a document or alternatively re-interpreting and rasterizing every page as it is being printed.

Just as with traditional offset presses, the substrate in digital printers can be sheet or web fed.

A sheet fed digital printer prints on sheets that are stored in a stack. The size of the sheets is rectangular and is usually fixed during a print job. A sheet fed digital press relies on a fairly complex sheet handling mechanism to pick the individual sheets from a stack, to feed them to a print station and to collect the printed sheets. The complexity of a sheet handling mechanism is a bottleneck for achieving high print throughput.

Such a bottleneck does not exist in web-fed systems because the substrate handling is more straightforward.

An example of a web fed based printing device is the Xeikon 5000 digital press marketed by Punch Graphics in Belgium. Another example is the Agfa Dotrix Modular digital press marketed and sold by Agfa-Graphics in Belgium. Web fed presses may or may not include an additional paper cutting stage to cut the web into individual pages.

Printed labels are used to identify objects or their contents. They are typically attached to an object using glue or a self-adhesive substrate. Examples of objects include compact discs, bottles, packaging boxes, computers, hardware etc.

### The Problem in the Prior Art as Explained for the Case of Label Printing

Labels can have many different shapes, such as rectangular, round, elliptical, star shaped or any other shape.

A label is typically designed using a design software application that is developed for this purpose.

A characteristic of traditional label printing is that the labels that are printed in a print run are all identical. For this purpose a printing master (e.g., an offset printing plate, a flexographic printing plate, a silk printing master) is created using a step and repeat process so that on one single printed sheet many identical labels can be printed. In a post-printing step the individual labels are then cut out or punched out from the printed sheet.

FIG. 2 shows an example of a printed sheet on which labels 200 are organized using a step and repeat process.

For certain applications, it is desirable to print labels having variable content. For example, a label can include a serial number of an object for which it is intended. One prior art technique uses a first printing step for printing the fixed contents of the label and an additional printing step for printing the variable data. Usually the first step uses a traditional printing technique, while the second step uses a digital printing technique, for example inkjet printing.

The availability of digital color printing presses enables to print in one single step both the fixed and the variable data.

A variation of a step and repeat process for a web fed printing press is shown in FIG. 3, where a first label 310 and a second label 320 are printed on a web. The printed web is collected on a roll.

In a traditional print process the replication in the transversal dimension 330 of the web is obtained by a digital step and repeat process before the print master is made, while replication in a longitudinal dimension 340 of the web is for example obtained by a combination of digital replication and using a rotating print master. The labels 310 and 320 in the transversal dimension may be the same or may be different as is the case in FIG. 3.

In a digital print system, the replication in both the transversal and longitudinal dimensions is obtained by means of a digital step and repeat process.

The printing is stopped when the required number of labels is printed.

In a next step the resulting print roll is usually split up by means of a splicing process into a plurality of narrow print rolls each one containing only one label in the transversal dimension of the print roll.

A first problem with a prior art method originates when substantially the same number of labels is needed of a first label 310 having a first length 311 (measured along the longitudinal dimension) and a second label 320 having a second length 321 that is different from the first length. The step and repeat process of both labels in the longitudinal dimension of the web inevitably results in a waste 350 of printed substrate.

A similar problem originates when a first number is needed of a first label having a first length and a second number of a label having a second length, wherein the first and second length are substantially the same, but wherein the first and second numbers are different.

In general, a prior art method results in the waste of printed substrate when a print job includes printing first 310 and second 320 labels on a single roll, whereby the product of the number of labels times the label length 311, 321 of the two labels is not identical.

It is clear that a solution is needed that enables the printing of labels on a web fed printing system in a way that minimizes the waste of unprinted substrate and that at the same time optimizes the use of print capacity along both the longitudinal and transversal dimensions of a web.

The same improved solution is needed for similar problems in digital package printing, transactional printing and commercial printing.

### SUMMARY OF THE INVENTION

In order to overcome the problems described above, preferred embodiments of the present invention include a method and a system as described below.

Specifically, the method and the system enable to reduce the waste of unprinted substrate in label printing, package printing, transactional printing and commercial printing while optimizing the use of print capacity.

A method and the system according to preferred embodiments of the present invention are particularly suited for use in combination with a web fed digital printing device.

A method according to a preferred embodiment of the present invention is explained below with reference to FIG. 4.

To achieve the above benefits and advantages, a user prepares separate documents including graphic objects described in a page description language. Each of these documents is then separately interpreted by an interpreter into a stream of interpreted print commands that defines a print job.

In a next step these multiple interpreted print command streams are multiplexed by a multiplexer and the multiplexed stream of interpreted print commands is rendered by a renderer into a bitmap. This bitmap is sent to a printer.

A print job in a specific print zone can be aborted and be followed by another print job, independent of the print jobs in another print zone. The width and/or the length of logical print zones can be fixed or they can dynamically vary as a function of the different print jobs that are being printed on the web.

By dynamically assigning multiple print jobs to print zones and dynamically adjusting their length and width, the waste of substrate can be substantially reduced, since each print zone can be given exactly the right dimensions to fit a specific print job.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 shows the different steps in a prior art method to design and print a document.

FIG. 2 shows a print master to print multiple identical labels using a step and repeat technique as known in a prior art technique.

FIG. 3 shows a variation of a step and repeat technique adapted for a web fed printing press as known in a prior art technique.

FIG. 4 shows the steps of a preferred embodiment of a method according to the present invention.

FIG. 5 shows a printing system according to a preferred embodiment of the present invention.

FIG. 6 shows a system to splice a web into multiple spliced webs according to a preferred embodiment of the present invention.

FIG. 7 shows a segment of a web having two logical print zones and having graphic objects in each print zone.

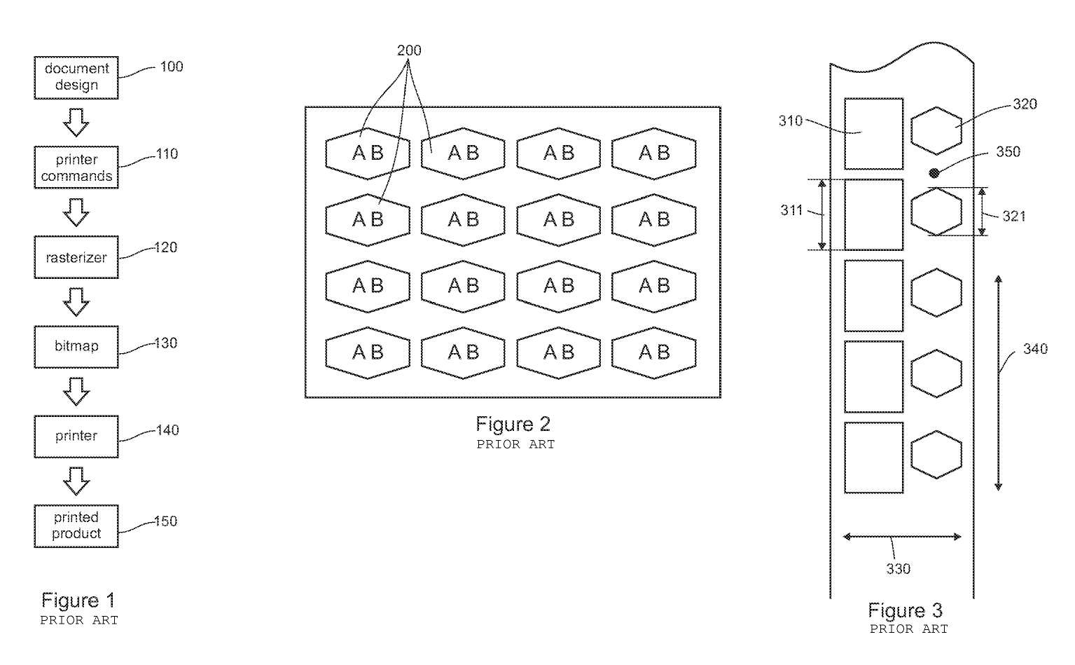

### DETAILED DESCRIPTION OF THE PREFERRED EMBODIMENTS

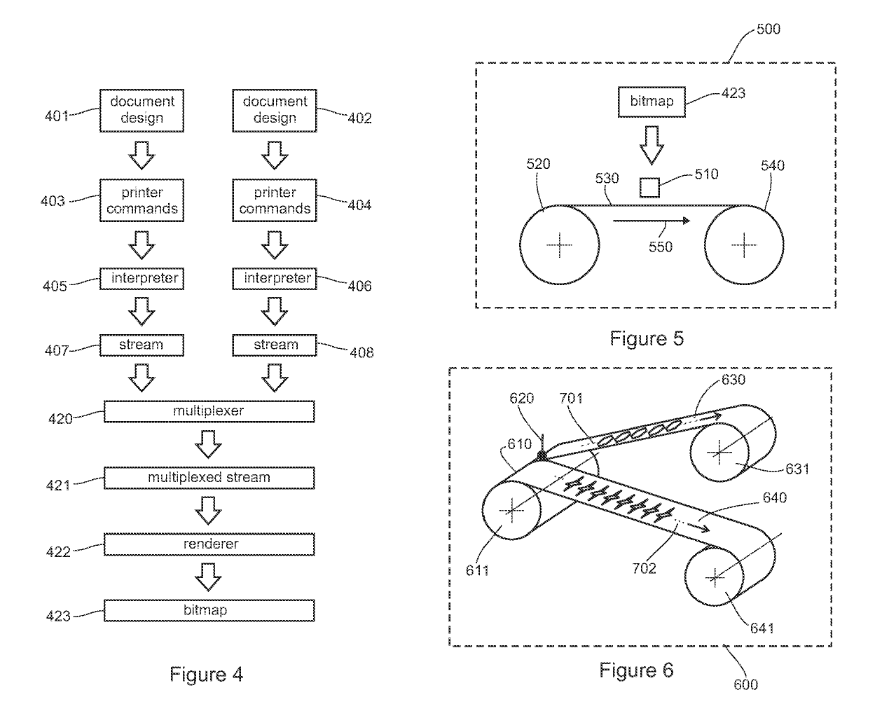

FIG. 4 to 6 show various elements of a system that can be used for carrying out preferred embodiments of the present invention.

### Document Design and List of Printer Commands

Preferred embodiments of the present invention assume that separate documents are prepared on one or more document editing systems 401, 402 that faithfully describe what needs to be printed, and that these edited documents are stored as a list of printer commands 403, 404 using a page description language.

In a first preferred embodiment a document is a label and the document editing system is a label editing system. In other preferred embodiments, a document is the cover of a package, a transactional document or a commercial print document.

The document design systems 401 and 402 may be different systems or they may be the same system that is time-shared. In the preferred embodiment shown in FIG. 4, only two printer command lists are shown, but in general there can be any number of printer command lists corresponding to a respective number of documents.

Printer commands are instructions for a rasterizer for rendering graphic objects. Graphic objects can for example be text, vector graphics or raster graphics. The graphic objects have a position on a fictitious canvas that digitally represents the substrate on which the objects are to be printed. The rendering of graphic objects involves transforming the objects into a bitmap having the same spatial and tone resolution as a printing device.

A text object includes text and information on how the text should be rendered, including a font type, a font size, and a font rendering intent (normal, bold, underlined, lowercase, italic, color . . . ).

A vector graphic includes a description of the contour of the graphic as well as information on how these contours should be rendered, including the color of the fill and the thickness and color of the boundaries.

A raster image object includes a map or matrix of pixel values and a translation, scaling and rotation matrix that maps the raster image to a specific position on the canvas.

Every graphic object is rendered at a current point, which is a fictitious point on the canvas. Special printer commands are available to set or change the current point to affect the position of a graphic object.

Every graphic object is optionally accompanied with an additional translation, scaling and rotation matrix to translate, scale or rotate the object on the canvas.

Graphic objects are rendered in the order they are listed. They may spatially overlap. A graphic object that occurs later in a list may overlap and cover a graphic object that occurs earlier in the same list. The overlapping of a first object over a second object may be opaque in which case the first object hides the second object in the overlapping area, or it may be transparent, in which case the two objects visually blend.

Special printer commands also exist to repeat the rendering of specific graphic objects or groups of graphic objects.

### Interpreter

The lists of printer commands 403, 404 are sent to interpreters 405, 406. In one preferred embodiment a single interpreter is used that is time shared to interpret multiple printer command lists.

An interpreter 405, 406 interprets a list of printer commands 403, 404 and produces an interpreted stream of printer commands 407, 408.

Interpreting involves determining a bounding box, i.e., a rectangular area on the canvas that entirely contains the graphic object. Interpreting a graphic object also involves transforming the object into a set of graphic primitives that are visually equivalent when rendered, but that enable fast rendering. For example, a circle can be transformed into a contiguous set of trapezoids that closely approximate the circle when rendered at the resolution of a specific printing device, and a character can be transformed into a bitmap having the tonal and spatial resolution of a printing device. In a preferred embodiment, interpreting involves rasterizing text objects. In a very preferred embodiment of the present invention, every character having a specific font type and font size that occurs in a text object is rasterized only once, and an interpreted text object includes the rasterized characters and a sequence of locations where the rasterized characters occur in the text object.

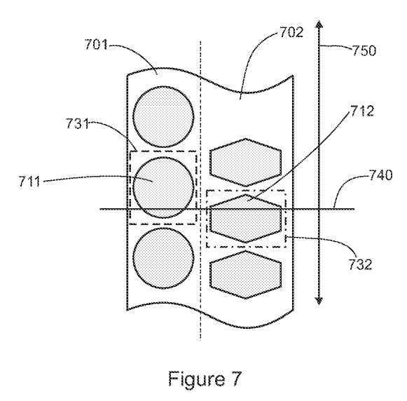

Interpreting a list of printer commands may also involve a step and repeat process, for example a step and repeat process in the transversal and/or the longitudinal dimensions. Referring to FIG. 7 a first graphic object or primitive 711 belonging to a first document is replicated along the longitudinal dimension 750 of a web of a printing device by means of a step and repeated process.

Referring again to FIG. 7, an interpreter associates with every graphic object or graphic primitive 711, 712 a bounding box 731, 732. This bounding box indicates the spatial scope of a graphic object or primitive.

Unlike traditional page description languages such as PostScript (™) or PDF (™), a stream of printer commands does not have to be page oriented. In principle, a stream can describe a document having an infinite length. A stream of printer commands is therefore suitable to describe a series of objects that are to be printed on a web based digital printing device.

### Logical Print Zone

According to a preferred embodiment of the present invention, the substrate of a printer is subdivided into logical print zones. A logical print zone is a printable area on a specific substrate having a shape and having dimensions that is defined on the unprinted stock and to which a print job is assigned.

In the case of web based digital printing device, a logical print zone may for example correspond to a rectangular area on a web of a specific stock having a length and a width that is optimized for a specific print job to include the printing of a specific number of specific labels.

### Multiplexer

The multiple streams of interpreted printer commands 407, 408 are multiplexed by a multiplexer 420.

The multiplexing preferably involves assigning a specific stream of interpreted printer commands 407, 408 to a specific logical print zone (701, 702) on a web of a printing system. This assignment may include a geometrical translation or another geometrical transformation such as a rotation or scaling of interpreted objects.

The effect of a multiplexing operation is also explained by means of FIG. 7. A first interpreted object 711 is assigned to a first logical print zone 701 and a second interpreted object 712 is assigned to a second logical print zone 702.

The multiplexing is preferably dynamic in that the number of logical printing zones, their width and length and the streams that are assigned to them may vary while the printing on the web takes place.

This dynamic multiplexing is preferably done in a way that minimizes the waste of unprinted stock during printing, taking into account the number and size of the labels that are to be printed. This is achieved not just by adjusting the area of a single logical print zone to a specific print job, but by optimizing the use of the complete area on a roll or on multiple rolls of unprinted stock as a function of multiple print jobs.

In this document this is called “dynamic multiplexing”. The stream of multiplexed data is conceptually not limited in length.

### Renderer

The multiplexed interpreted printer command stream 421 is sent to a renderer 422.

The renderer 422 renders the graphic primitives, i.e., calculates the values of the pixels of the bitmap that have the same tonal and spatial resolution as a printing device.

The principles of rendering graphic objects are known to a person skilled in the art and are for example found in the chapter “Basic Raster Graphics Algorithms for Drawing 2D Primitives” in the book “Introduction to Computer Graphics”, edited by James D. Foley . . . [et al] published by Addison-Wesley Publishing Company in New York.

The advantage of transforming objects into graphic primitives in a first step and rendering the graphic primitives into a bitmap in a second step is that the overall transformation process can be implemented more efficiently because the rendering of the graphic primitives can be implemented computationally more efficiently than the direct rendering of complex objects.

According to a preferred embodiment of the present invention, the rendering of graphic primitives is done by a graphic primitive processor that is, for example, implemented using software embedded on a Field Programmable Gate Array (FPGA).

The rendering process of graphic primitives is preferably organized in row by row and pixel by pixel fashion.

Referring to FIG. 7, to render an active row 740 of pixels (i.e., a row of pixels that is being rendered), a list of active interpreted objects is consulted. An interpreted object is said to be active if its associated bounding box overlaps with the active row of pixels. As the rendering process proceeds and the rows of pixels are processed, new interpreted objects come into scope and become active and other interpreted objects go out of scope and become non-active. For this purpose the active interpreted object list is updated every time a row of pixels has been rendered.

Because the rendering of graphic objects and raster image objects typically produces pixels having a tonal resolution (for example 8 bits per colorant component) that is higher than the tonal resolution (for example 1 bit per colorant component) of a printing device, the rendered pixels are halftoned in a halftoning step to obtain a bitmap having pixels at the same tonal resolution of the printing device. Halftoning methods are well known to a person skilled in the art and include, for example, the “error diffusion” algorithm.

Referring again to FIG. 4, the end result of the rendering step is a bitmap 423 that is ready to be sent to a printing device.

The bitmap 423 that is produced by the renderer 422 is preferably buffered in bands of rows of pixels.

### Printing Device

According to a preferred embodiment, the printing device is a web fed printing device 500. It includes a first roll 520 containing unprinted stock, a web 530 and a roll containing printed stock 540. The web moves in a direction 550 and printing takes place at a marking station 510. The marking station can be inkjet, toner based or any other marking station. It can be a monochrome or a color marking station. The marking station puts colorant onto the web in response to the pixel values of the bitmap 423 that is sent to the printing device 500. The printing device includes a buffer (not shown in FIG. 5) that can contain a band of rows of pixels produced by the renderer. Web based digital printing systems are well known to a person skilled in the art and they are not further elaborated here.

The bitmap that is rendered and printed is conceptually not limited in a transversal dimension 550 of a web. In practice, a renderer will stop rendering when a print job is finished or when the first roll 520 of unprinted stock stops feeding the web 530.

### Splicing Device

According to a preferred embodiment, a system according to a preferred embodiment of the present invention also includes a splicing device 600 to splice a single web 610 on a roll 611 into multiple webs 630, 640 on rolls 631, 641. The slicing is for example achieved by a cutter 620, which cuts the original web 610 along the boundary between two print zones 701, 702.

Alternatively a different method for cutting the web is used such as a laser based slicing system. In yet another alternative a laser based die cutter is used to cut out the individual labels. The multiple webs 630, 640 are rolled on rollers 631, 641 for storage.

Splicing devices are well known to a person skilled in the art and they are not further elaborated here.

### Cutter

In a later stage, a cutter can cut a web 630 on a roller 631 into individual documents.

### OTHER MODES FOR CARRYING OUT THE PRESENT INVENTION

The terms “interpreting”, multiplexing” and “rendering” should not be construed in a restrictive way.

For example, while in the above preferred embodiments, the multiplexing takes place on objects that include graphic primitives, the multiplexing can also take place on the graphic objects that have been interpreted but are not converted into graphic primitives during the interpreting. This approach increases the complexity of a renderer, as it is required to be capable of rendering more complex graphic objects instead of graphic primitives.

In an alternative preferred embodiment, the objects that are multiplexed are already rasterized during the interpreting step, i.e., represented as bitmaps of pixels. This approach enables to reduce the complexity of the renderer, as it is not required to be capable of transforming graphic primitives into bitmaps of pixels. Reducing the complexity of a renderer offers the advantage that such a renderer is easier to implement in software embedded on a Field Programmable Gate Array.

In yet another preferred embodiment, the interpreting step produces bitmaps representing a complete page of a document. This reduces the complexity of the renderer even more.

In yet another preferred embodiment, the interpreted rasterized objects have already been halftoned. This reduces the complexity of the renderer even more.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-12. (canceled)

13: A method for rendering multiple print jobs, the method comprising the steps of:
creating first and second documents including a first list of printer commands and a second list of printer commands;
interpreting the first list of printer commands and the second list of printer commands to obtain first and second streams of interpreted printer commands defining first and second print jobs;
assigning the first print job to a first logical print zone;
assigning the second print job to a second logical print zone;
multiplexing the first and the second streams of interpreted printer commands to obtain a multiplexed stream of interpreted printer commands; and
rendering the multiplexed stream of interpreted printer commands to obtain a multiplexed bitmap addressing both the first and second logical print zones.

14: The method according to claim 13, further comprising the steps of:
sending the multiplexed bitmap to a printer; and
printing the multiplexed bitmap on a substrate.

15: The method according to claim 14, wherein the step of printing is an inkjet printing method.

16: The method according to claim 14, further comprising a step of:
slicing the printed substrate.

17: The method according to claim 15, further comprising a step of:
slicing the printed substrate.

18: The method according to claim 13, wherein each of the first and second interpreted streams of printer commands includes at least one object selected from the set of a graphic object, a graphic primitive, and a bitmap.

19: The method according to claim 14, wherein each of the first and second interpreted streams of printer commands includes at least one object selected from the set of a graphic object, a graphic primitive, and a bitmap.

20: The method according to claim 18, wherein the at least one bitmap represents a complete rasterized page of a document.

21: The method according to claim 19, wherein the at least one bitmap represents a complete rasterized page of a document.

22: A system for rendering printer commands, the system comprising:
a first interpreter arranged to receive and interpret a first stream of printer commands to obtain a first stream of interpreted printer commands defining a first print job;
a second interpreter arranged to receive and interpret a second stream of printer commands to obtain a second stream of interpreted printer commands defining a second print job;
a multiplexer arranged to assign the first print job to a first logical printing zone, to assign the second print job to a second logical printing zone, and to multiplex the first and the second streams of interpreted commands to obtain a multiplexed stream of interpreted printer commands; and
a renderer arranged to render the multiplexed stream of interpreted printer commands to obtain a bitmap addressing both the first and the second logical print zones.

23: The system according to claim 22, the system further comprising:
a printer arranged to print the bitmap on a substrate.

24: The system according to claim 23, wherein the printer includes an inkjet printer.

25: The system according to claim 22, further comprising a slicing system arranged to slice the substrate into the first printed zone and the second printed zone.

26: The system according to claim 24, further comprising a slicing system arranged to slice the substrate into the first printed zone and the second printed zone.

27: The system according to claim 25, further comprising a slicing system arranged to slice the substrate into the first printed zone and the second printed zone.

28: The system according to claim 22, wherein the renderer includes a Field Programmable Gate Array.

29: The system according to claim 23, wherein the renderer includes a Field Programmable Gate Array.

30: The system according to claim 24, wherein the renderer includes a Field Programmable Gate Array.

31: The system according to claim 25, wherein the renderer includes a Field Programmable Gate Array.
